(19) United States
(12) Patent Application Publication
(10) Pub. No.: US 2007/0060434 A1
(43) Pub. Date: Mar. 15, 2007

(54) Drive train of an all-wheel drive vehicle comprising clutches and method for controlling and regulating a drive train

(76) Inventors: Detlef Baasch, Friedrichshafen (DE); Gerhard Gumpoltsberger, Friedrichshafen (DE); Christoph Pelchen, Tettnang (DE); Barbara Schmohl, Friedrichshafen (DE); Ulrich Mair, Friedrichshafen (DE); Thomas Rosemeier, Meckenbeuren (DE)

Correspondence Address: DAVIS & BUJOLD, P.L.L.C., 112 PLEASANT STREET, CONCORD, NH, 03301, US

(21) Appl. No.: 10/572,609

(22) PCT Filed: Sep. 21, 2004
(86) PCT No.: PCT/EP04/10552

§ 371 Date: Mar. 20, 2006

(51) Int. Cl. B62D 11/06

(52) U.S. Cl. 475/18

(57) ABSTRACT

A power train (1) of an all-wheel drive vehicle with at least two driven vehicle axles (4, 5), with a main transmission (3) placed between a main engine (2) and the vehicle axles (4, 5), capable of displaying different conversion ratios, which has three control and adjustment frictional clutches (k_VA, k_HA_L and k_HA_R). The first clutch (k_VA) is placed between the main transmission (3) and the first vehicle axle (4) and the second clutch (k_HA_L) and the third clutches (k_HA_R) are respectively located between an axle transmission (7) and two driven wheels (5A, 5B) of the second vehicle axle (5). The respective transfer capabilities of the clutches (k_VA, k_HA_L, k_HA_R) can be adjusted with an actuator (8), and the driving torque between the driven vehicle axles (4, 5) can be distributed depending on the adjusted transfer capabilities of the clutches (k_VA, k_HA_L, k_HA_R).

This application is a national stage completion of PCT/EP2004/010552 filed Sep. 21, 2004 which claims priority from German Application Serial No. 103 44 972.8 filed Sep. 27, 2003.

### FIELD OF THE INVENTION

The invention concerns a power train for all-wheel drive vehicles with at least two vehicle axles and a main transmission system arranged between the main engine and the vehicle axles, and a system for controlling and adjusting such a power train.

### BACKGROUND OF THE INVENTION

The vehicles known in practice are started by a driving torque generated by a main engine, which is transferred by the power train to the transmission, and the vehicle is propelled, depending on the corresponding adjusted conversion transformation ratio to the driven wheels. In vehicles such as all-wheel drive passenger automobiles or all-wheel drive freight vehicles, which are driven by multiple vehicle axles, the power train main engine power output will be distributed depending on the different power flows assigned to each vehicle axle.

The power output distribution is typically performed in the so called differential transmission, where the longitudinal differential seen in the driving direction is used for the longitudinal distribution of the main engine power output into the different driven axles of the vehicle. The so-called transverse differential or compensation gearbox is used along the driving direction of a vehicle to make a transverse distribution of the main engine power output to the driven wheels by the vehicle's axle.

The most widely used differential types of construction are the rack and pinion differentials, the spur gear differentials, the planetary construction differentials and the worm gear differentials. In particular, the spur gear differentials provide a broader possibility of distributing the torque asymmetrically than the longitudinal differentials. In the meantime, the rack and pinion differentials produce a standard transverse compensation for the vehicle and the worm gear differentials offer both a longitudinal distribution and a transverse distribution of the transmission output torque from the power train.

With the aid of such transmission distributors, it is possible to divide the power train torque between multiple axles in almost any given proportion, without generating excessive loads to the power train. In addition, with the input from the compensating transmission, the wheels of an axle can be driven with different rotational speeds, independent between each other and, depending on the different path lengths of the left and right lanes, whereby the driving torque is distributed among both driven wheels symmetrically and free of parasite torque.

The established torque distribution between the front and rear axles can be from 50%:50% to 33%:66%. In rack and pinion differentials, the torque distribution is fixed at 50%:50%. By selecting one of these fixed torque proportions between front and rear axles, the driving force distribution is ideal for only one design point.

Consequently, the driving torque is not distributed proportionally among the corresponding axle loads, which depend on the instantaneous driving conditions. If the traction reserves must be used completely in case of high slippage, in theory it is only possible to brake or block the variable torque distribution between the front and rear axles of an automobile with a longitudinal differential. The vehicle handling would not be negatively influenced by a continuously incipient blocking effect with an increasing rotational speed difference, such a viscous blocker, and a consistent development of loads in the power train can be avoided when positive fitting barriers arise.

The so-called clutch controlled, all-wheel drives are increasingly common, in which the clutch is carried out with external adjustable clutch torques, for example, multiple disk clutches. The clutch torque can be selected depending on the instantaneous driving conditions. It is then possible to customize the instantaneous axial load distribution between the front and rear axles, depending on the dynamic axial load conditions, which also depend on the acceleration, slope, vehicle load, etc.

Further hybrid forms are also known, such as the so called differential and clutch controlled systems, where the all-wheel drive is carried out by an electronically switchable, multiple, disk clutch and/or a lockable differential.

It is unfavorable, however, that a variable torque distribution is reached in a power train by a slippery drive operation, which has in consequence an adverse effect on the efficiency degree of such a power train.

Therefore, the invention under consideration is based on the power train requirements and in a system for controlling and adjusting a power train, where a simple, customized and efficient optimized distribution of the driving torque is feasible.

### SUMMARY OF THE INVENTION

With the power train involved by the invention, an all-wheel drive vehicle with at least two driven axles and a main transmission between the main engine and the driven axles, which generates different conversions with three control and adjustment frictional clutches, where a first clutch is located between the main transmission and a first driven axle. A second and third clutch, each are located between the axle transmission downstream. The main transmission and a driven wheel of the second vehicle axle, where the forward transferring capability of the clutch is respectively adjustable by an actuator, and the driving torque of the main engine can be distributed both lengthwise between the driven vehicle axles as well as in the transverse direction in one of the vehicle axles depending on the variable forward transferring capability of the clutch.

A beneficial possibility exists whereby the driving torque of the power train's main engine can be distributed in the output driving torque of the main transmission, respectively, depending on the operating conditions of the power train in such a way that in critical driving situations, a vehicle equipped with the invention defined power train is provided with a safety optimized driving performance.

In addition, with the invention defined power train exists the possibility that respectively one of the clutches makes a synchronized variable distribution of the driving torque lengthwise between the driven vehicle axles and in the transverse direction between two driven wheels. Meanwhile the two other clutches are slip operated.

Thereby, it can be accomplished that the power dissipation of a vehicle's clutch controlled all-wheel transmission is carried out in two clutches, while the third clutch is operated without losses in a synchronous condition.

The corresponding arrangement of the second clutch and the third clutch between the axle's transmission and each of the driven wheels of the two vehicle axles, makes it possible to improve the demand controlled transverse distribution of the existing driving torque from the power train in the two vehicle axles, whereby the driving behavior of a vehicle can simply work against deteriorated operating conditions, while the agility can be improved as well as the driving stability, for example while driving on curves.

With the defined system for controlling and adjusting the power train of an all-wheel drive vehicle, the transfer capability of the three clutches for distributing the driving torque, between the driven vehicle axles, is adjusted in such a way that one clutch will operate in a synchronous condition, while the two other clutches slip operate, improving the degree of efficiency of the power train in a simple way. Therefore, the transfer capability of the clutches operates slipping between an upper limit value and a lower limit value in which a synchronous condition of both clutches can be varied. Hereby the operating torque is distributed in a user defined proportion. This is a lengthwise distribution ratio of the driving torque between 0% and 100% between the driven vehicle axles, demand controlled and efficiently optimized.

In addition, the portion of the driving torque is applied to the two vehicle axles in a defined ratio. This means that a driving torque transverse distribution ratio between 0% and 100%, among the driven wheels of the two vehicle axles, can be controlled depending on the demand and its efficiency level can be optimized.

Furthermore, according to the invention for controlling and adjusting the power train, exists the possibility of operating one of the three clutches in a slip free condition. The other two clutches can be operated with one of the needed power output distributions and low differential rotational speeds, by which the power losses can be favorably reduced, leading to an improved efficiency degree of the power train.

In addition, the drive operation of a vehicle equipped with the invention related power train is also favorably guaranteed when two of the three clutches show a functional deficiency.

### BRIEF DESCRIPTION OF THE DRAWINGS

The invention will now be described, by way of example, with reference to the accompanying drawings in which:

FIG. 1 is a strong schematic representation of a power train in an all-wheel drive vehicle;

FIG. 2 is a graphical representation of the connection between the transfer capability of a first clutch, a second and a third clutch of the power train, according to FIG. 1, and a longitudinal distribution degree of the driving moment between the vehicle axles driven by the power train;

FIG. 3 is a further graphical representation of the connection between the transfer capability of the second clutch and the third clutch of the power train, according to FIG. 1, and a transverse distribution degree of the driving torque between the driven wheels of the two vehicle axles;

FIG. 4 represents a part of the actuators for adjusting the transfer capability of the second clutch and the third clutch from FIG. 1; and

FIG. 5 represents a part of the actuators for adjusting the transfer capability of the first clutch from FIG. 1.

### DETAILED DESCRIPTION OF THE INVENTION

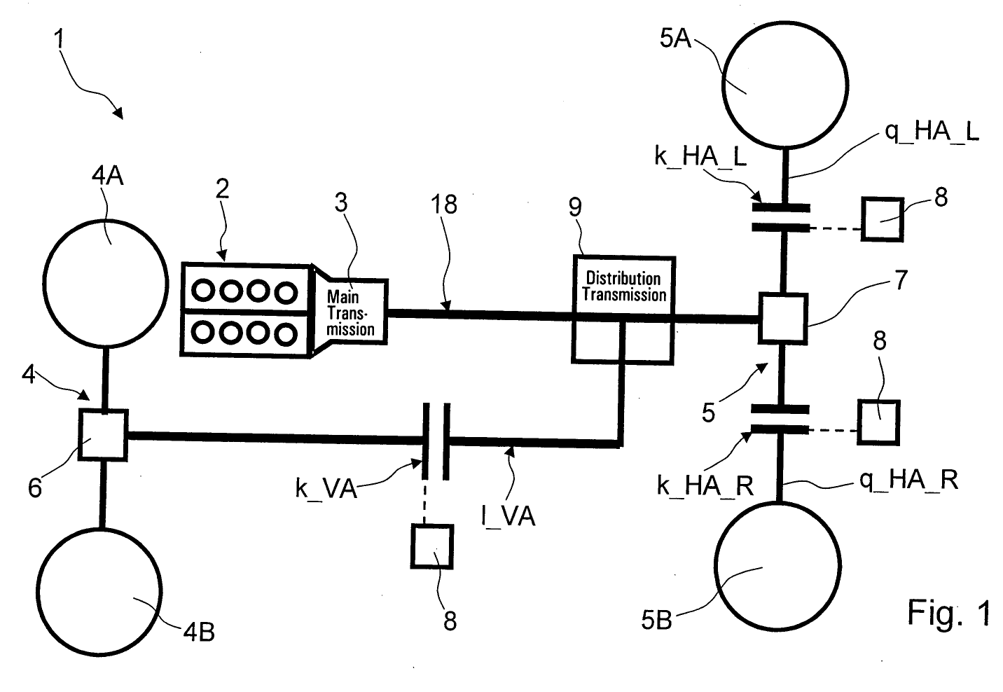

FIG. 1 shows a schematic representation of a power train 1 of an all-wheel drive vehicle. Power train 1 comprises a driving unit 2 and a main transmission 3, each of which in practice is a known transmission. The driving unit 2 is represented in the application example of FIG. 1 as a braking force machine and can be built from an electric motor for a beneficial further training.

Between the main transmission 3, which is intended for showing different conversion ratios, and a first driven vehicle axle 4, which in a known way can be connected with at least one driven wheel 4A, 4B, is a first clutch k_VA arranged in a longitudinal power train. The first clutch k_VA is between the main transmission 3 and a mechanism 6 which balances through differential rotational speeds and is placed between the driven wheels 4A and 4B, the first vehicle axle 4, whereby the mechanism 6 is used as a known transverse distributing transmission.

Beyond this, a second clutch k_HA_L as well as a third clutch k_HA_R are located in transverse transfer boxes q_HA_L and q_HA_R, between an axle transmission 7 over which one of two driven vehicle axles 5 routes part of the driving torque of the braking machine 2 in a mechanism where two driven wheels 5A, 5B of the second vehicle axle 5 and each one of the vehicle wheels 5A, 5B of the two vehicle axles 5 are routable.

It is possible to power the driven wheels 4A and 4B of the first vehicle axle 4 independently from each other, depending on the different distances covered over the right and left lanes with variable rotational speeds over the transverse transfer box 6, whereby the driving torque can be symmetrically and consequently free of parasite torques distributed between the driven wheels 4A and 4B of the first vehicle axle 4.

In contrast, the transverse distribution of the applied portions of the driving torque over the second vehicle axle 5 is carried out by the variable adjustable transfer capability of both clutches k_HA_L and k_HA_R, whereby preferably each one of both clutches k_HA_L and k_HA_R will be operated in synchronous conditions, and the other k_HA_L and k_HA_R clutches will be run slipping. Thereby, the transverse distribution ratio of the applied driving torque portions to the second vehicle axle 5, from 0% to 100% based on the feasibility of either driven wheels 5A or 5B, will depend on the transfer capability of the slip operating clutches k_HA_L and/or k_HA_R of the second vehicle axle 5.

Thereby the transverse distribution ratio of the control of the second clutch k_HA_L and the third clutch k_HA_R is associated in such a way that the entire fraction of the driving torque, which is applied to the second vehicle axle 5, is 100% transferred to the driven wheels 5A or 5B, then added to the synchronized operated clutches k_HA_L and/or k_HA_R when each of the other k_HA_L and/or k_HA_R clutches are driven by the transverse distributor q_HA_L and q_HA_R with one of such reduced transfer capabilities so that no driving torque is transferred to these clutches.

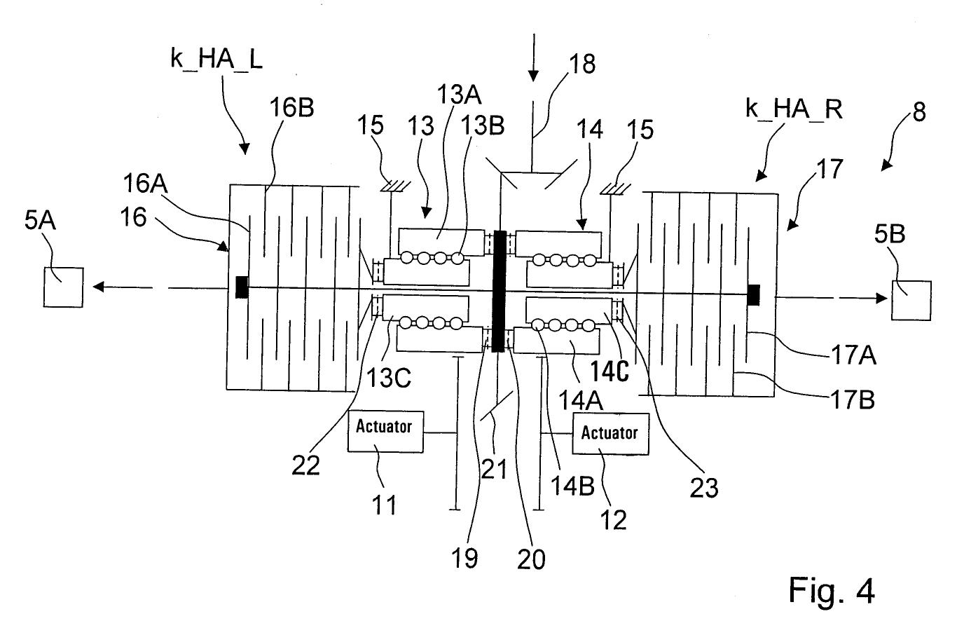

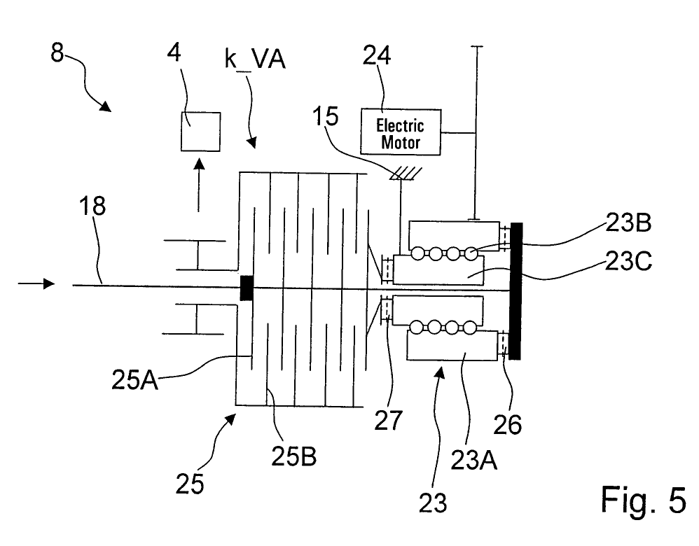

The three clutches k_VA, k_HA_L and k_HA_R of the power train 1 are control and adjustment friction engaged multiple disk clutches, whose transfer capability is adjustable with an actuator 8, shown in FIG. 4 and FIG. 5, which is placed in the output side of the transmission output and is simply schematically displayed and located in an illustrated distributing transmission 9. With these three clutches k_VA, k_HA_L and k_HA_R, it is possible to distribute the driving torque from main engine 2 as well as the variable and demand controlled transmission output torque from main transmission 3 between the two driven vehicle axles 4, 5.

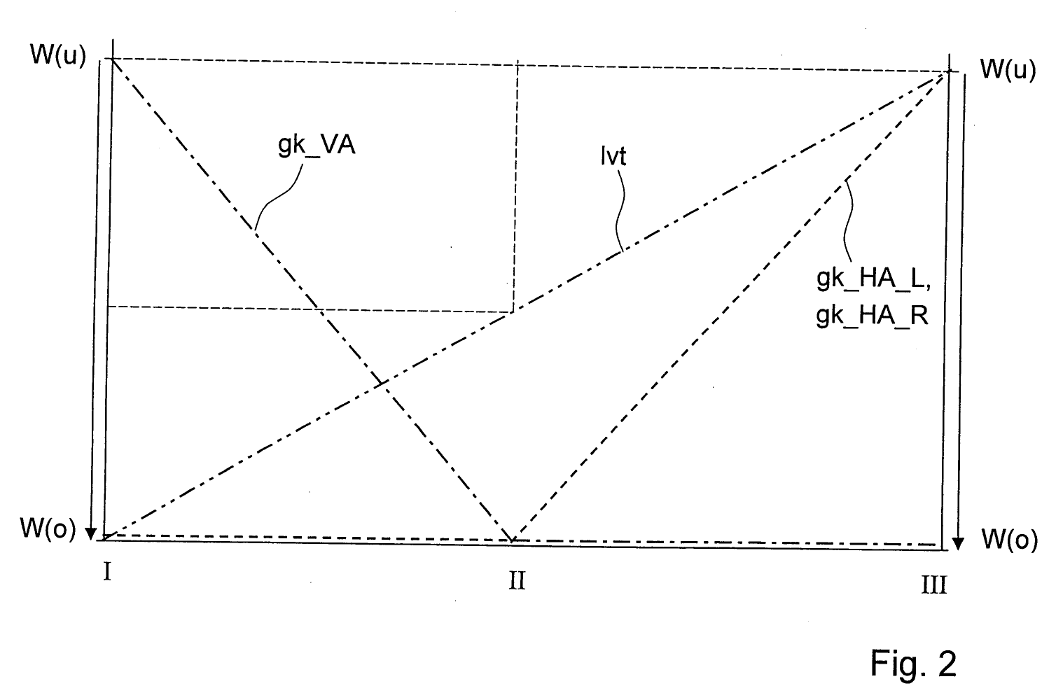

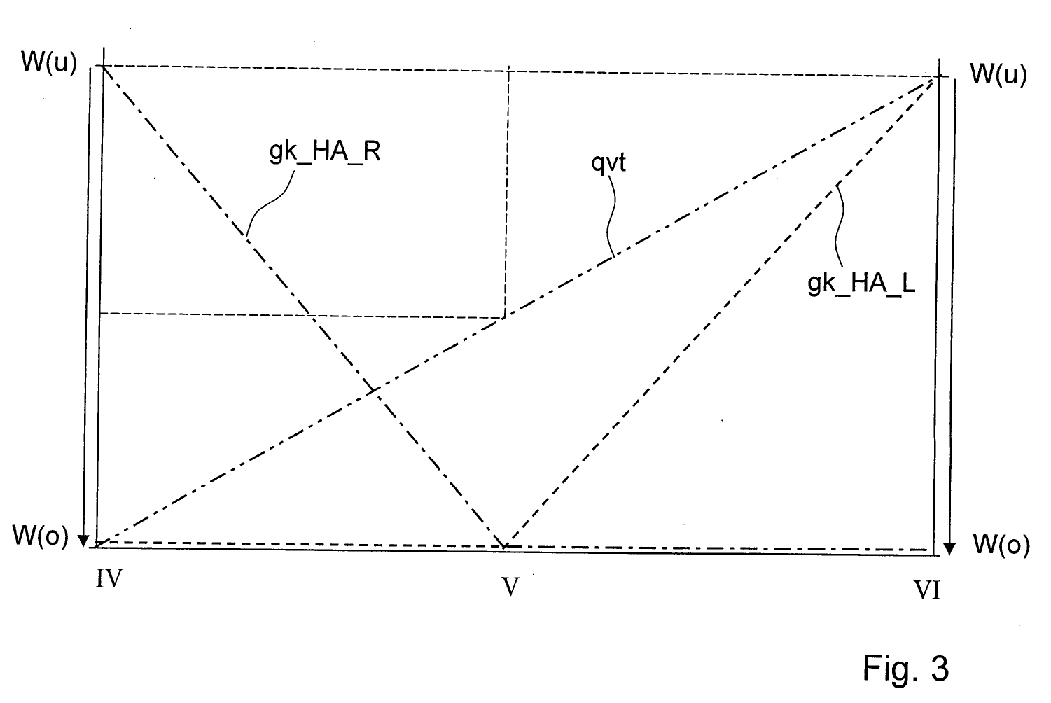

The control of the three clutches k_VA, k_HA_L and k_HA_R, as well as the resulting variable distribution of the adjacent lengthwise driving torque from both vehicle axles 4 and 5, is clearly explained on FIG. 2. The previously-described transverse distribution of the two driving torque fractions applied in the direction of the two vehicle's axles 5 from both driven wheels 5A and 5B on the second vehicle axle 5 will be further described in more detail in FIG. 3.

FIG. 2 illustrates three strong schematic stages, of which a first stage gk_VA of a stage of the transfer capability of the first clutch k_VA is shown between a lower limit value W(u) and an upper limit value W(o). A further stage gk_HA_L, gk_HA_R shows the stage of the transfer capability of the second clutch k_HA_L or of the third clutch k_HA_R, which corresponds to the gk_VA transfer capability of the first clutch k_VA. A third stage lvt graphically displays the driving torque distribution lengthwise between both vehicle axles 4 and 5, whereby the first vehicle axle 4 corresponds to the front axle (VA) and the second vehicle axle 5 corresponds to the rear axle (HA) of an all-wheel vehicle.

On Point I of the diagram according to FIG. 2, in which the transfer capability of the first clutch k_VA corresponds to the lower limit value W(u).

Basically, no rotational torque will be transferred over the first clutch k_VA. At the same time, the transfer capability of the second clutch k_HA_L or the transfer capability of the third clutch k_HA_R correspond to the upper limit value (Wo), on which the second clutch k_HA_L or the transfer capability of the third clutch k_HA_R operate in a synchronous condition. There is no slippage between the two clutch halves of the second clutch k_HA_L and the third clutch k_HA_R. In this operating condition, the clutches k_VA and k_HA_L and/or k_VA_R distribute the entire driving torque from the main engine 2 between the rear axle and the second vehicle axle 5, while the lengthwise distribution ratio obtained from the first vehicle axle 4 is zero.

The basic principle for controlling the three clutches k_VA, k_HA_L and k_HA_R of the power train 1 is that over the entire operating range of the power train, each of the three clutches k_VA, k_HA_L and k_HA_R are run in synchronous condition, while the other clutches k_HA_R and k_HA_L or k_HA_R or k_VA operate slipping, and the driving torque lengthwise distribution ratio lvt, between the two vehicle axles 4 and 5, is regulated by the demand between 0% and 5%.

The entire graphical illustration of the transfer capability of the second clutch k_HA_L and the third clutch k_HA_R, shown in FIG. 2, therefore, can be selected. As with an open first clutch k_VA in a synchronous condition, the driving torque from the braking force machine 2 is completely applied to the second vehicle axle 5 by each of the two clutches k_HA_L and k_HA_R. The driving torque will be completely applied by an opened first clutch k_VA and the synchronously operated second clutch k_HA_L or the third clutch k_HA_R, independently from the adjusted transfer capability of the third clutch k_HA_R or the second clutch k_HA_L, controlled by the second vehicle axle 5. A transfer capability variation of the second clutch k_HA_L or the third clutch k_HA_R, while the third clutch k_HA_R or the second clutch k_HA_L operate synchronously, are simply applied to a transverse distribution ratio variation qvt, shown in FIG. 3, wherefore from this functionality was first introduced in the description of FIG. 3.

It can be further inferred from FIG. 2 that the transfer capability of the second clutch k_HA_L is controlled and adjusted in such a way that in the range between Point I and a second Point II of the diagram, shown in FIG. 2, indicates that the second clutch k_HA_L remains in the synchronous condition. In this context, the transfer capability of the third clutch k_HA_R is basically not varied for the lengthwise distribution ratio lvt stage of the driving torque and can be varied for adjusting a desired transverse distribution ratio qvt of the second vehicle axle 5 applied fraction of the driving torque on the second vehicle axle 5 between the lower limit value W(u) and the upper limit value W(o), without adjusting another value for the lengthwise distribution ratio lvt. The lengthwise distribution ratio lvt will be displayed initially only by the variation of the transfer capability of the first clutch k_VA, which is graphically displayed in FIG. 2, on the gk_VA stage of the transfer capability of the first clutch k_VA.

The transfer capability of the first clutch k_VA is transferred between the first Points I and II from its lower limit value W(u), with which the first clutch k_VA transfers no rotational torque, varying the transfer capability in the direction of the upper limit value W(o), by which the first clutch k_VA, likewise, is found in its synchronous condition. This means that the transfer capability of the first clutch k_VA is continuously raised in the range between Point I and Point II. This has the consequence that the lengthwise distribution ratio lvt of the driving torque varies between both the vehicle axles 4 and 5, with which the rising transfer capability of the first clutch k_VA, an increasing fraction of the driving torque is applied in the direction of the front vehicle axle 4.

With the existing operating condition of the power train 1, that corresponds to Point II of the diagram, according to FIG. 2, and in which both the first clutch k_VA and the second clutch k_HA_L are found in synchronous condition, exists a defined driving torque distribution ratio between the vehicle axles 4 and 5.

The transfer capability of the first clutch k_VA is controlled and adjusted within an area between Point II and Point III of the diagrams, according to FIG. 2, so that the first clutch k_VA is kept in its synchronized condition. At the same time, the transfer capability of the second clutch k_HA_L is continuously reduced, moving away from the upper limit value W(o) on which the second clutch k_HA_L is in a synchronized condition, in the direction of the lower limit value W(u), with which the second clutch k_HA_L basically transfers no more rotational torque in the direction of the lower vehicle axle 5.

As can be inferred from FIG. 2, the lengthwise driving torque distribution ratio lvt of the stage rises between the vehicle axles 4 and 5 with an increasing reduction of the second clutch k_HA_L transfer capability up to the maximum value in Point III, on which the driving torque is completely, i.e., to 100%, transferred to the front axle 4, whereby the transfer capability of the third clutch k_HA_R is also adjusted in Point III to the lower limit value W(u).

This means that the value range of the lengthwise distribution ratio lvt, which lies between Points II and III of the diagram according to FIG. 2, is therefore adjustable, so that the first clutch k_VA is operated in a synchronous condition and the second clutch k_HA_L and the third clutch k_HA_R simultaneously are operated slipping. The driving torque is applied up to 100% on the first vehicle axle 4, when the second clutch k_HA_L and the third clutch K_HA_R transfer no more rotational torque.

By way of the described operating way, it is possible to control the driving torque from the braking machine 2 and the transmission output torque from the main transmission 3 through the three control and adjustment clutches k_VA, k_HA_L and k_HA_R, distributing it continuously and optimizing the efficiency factor between the vehicle axles 4 and 5. With both clutches k_HA_L and k_HA_R on the second vehicle axle 5, it is feasible to achieve a demand controlled, continuous and efficient degree optimized transverse distribution of the driving torque fractions applied on the second vehicle axle 5, between the two driven wheels 5A and 5B of the second vehicle axle 5.

An improvement of the efficiency factor of the power train 1 can be reached by applying the invention defined approach for controlling and adjusting the three clutches, as one of the three clutches k_VA, k_HA_L and k_HA_R is always operated without slipping, while the other two clutches are operated with one of the operating conditions that depend on the required power distribution in the power train with their corresponding rotational speeds. By way of this operating strategy, the friction losses are minimized with all the fractions of a clutch controlled all-wheel operation.

In addition, the favorable possibility exists that by applying the three control and adjustment clutches k_VA, k_HA_L and k_HA_R in the distribution transmission 9, the main transmission 3 can be actuated without a separate starting element, for example, a hydrodynamic torque converter or a frictionally engaged starter clutch, or that a starter element must be integrated in the power drive as an additional constructive element, as either the first clutch k_VA, the second clutch k_HA_L and/or the third clutch k_HA_R or all three clutches can transfer that function to another starter element.

If the main transmission 3 is arranged as a continuous transmission with a chain variator, for example, there is the favorable possibility of adjusting the existing variator on the vehicle to its starting transfer setting, when the clutches k_VA, k_HA_L and k_HA_R are opened and detached from the main transmission 3.

Furthermore, an optimal influence over the driving dynamics, the traction and the stability is ensured by applying the invention defined power train and system with the three clutches k_VA, k_HA_L and k_HA_R, while the power train 1 has also a lower weight in comparison with other known solutions in practice.

FIG. 3 shows three schematized stages, whereof a first stage gk_HA_L, a stage of the transfer capability of the second clutch k_HA_L is shown between a lower limit value W(u) and a higher limit value W(o). A further stage gk_HA_R shows the stage of the transfer capability of the third clutch k_HA_R, to which corresponds the gk_HA_L stage of the second clutch k_HA_L. A third stage qvt graphically shows the stage of a transversal distribution ratio of the driving torque portions applied to the second vehicle axle 5 between both driven wheels 5A and 5B of the second vehicle axle 5.

In Point IV of the diagrams according to FIG. 3, in which the transfer capability of the second clutch k_HA_L corresponds to the lower limit value W(u), will basically transfer no rotational torque over the third clutch K_HA_R. At the same time, the transfer capability of the second clutch k_HA_L is set on the upper limit value W(o), on which the second clutch k_HA_L is found in a synchronous condition and no slipping develops between the two clutch halves of the second clutch k_HA_L.

In this operating condition, the clutches k_HA_L and k_HA_R will apply the corresponding fraction of the driving torque from the main engine 2 to the driven wheel 5A of the second vehicle axle 5, whereas no rotational torque is applied over the third clutch k_HA_R from the second driven wheel 5B of the second vehicle axle 5.

In the region between Point IV and Point V of the diagram, according to FIG. 3, the transfer capability of the first clutch k_VA is controlled and adjusted in such a way that the first clutch k_VA is kept in its synchronous position. At the same time, the transfer capability of the third clutch k_HA_R is found on its lower limit value W(u), in which no rotational torque is transferred in the direction of the upper limit value W(o) while the transfer capability is varied, and the third clutch is also found on its synchronous condition.

This means that the transfer capability of the third clutch k_HA_R is consequence of this is that the distribution ratio of the applied portion of the driving torque to the two driven wheels 5A and 5B of the second vehicle axle 5 changes with the increasing transfer capability of the third clutch k_HA_R. An increasing fraction of the applied driving torque fraction to the second vehicle axle 5 is transferred to the second driven wheel 5B of the second vehicle axle 5.

When the operating conditions of power train 1 lie within the area of the second vehicle axle 5, Point V of the diagram, according to FIG. 3, corresponds to the second clutch k_HA_L and the third clutch k_HA_R when they are found in their synchronous condition. So the driving torque applied to the second vehicle axle 5 is distributed in equal parts between the two driven wheels 5A and 5B of the second vehicle axle 5. This transversal distribution qvt of the driving torque is adjusted while the vehicle is operated on even roads and without a noticeable slipping value in the range of the driven wheels 5A and 5B of the second vehicle axle 5, whereby a beneficial reduction of the power losses in the power train is reached in the region of the second clutch k_HA_L and the third clutch k_HA_R in a simple way.

In the area between Point V and Point VI of the diagram, according to FIG. 3, the transfer capability of the third clutch k_HA_R is controlled and adjusted, so that the third clutch k_HA_R can be kept in its synchronized condition. At the same time, the transfer capability of the second clutch k_HA_L constantly moves away from the upper limit value W(o) of the transfer capability, in which the second clutch k_HA_L is synchronized, reducing in the direction of the lower limit value W(u), in which the second clutch k_HA_L basically transfers no more rotational torque in the direction of the first driven wheel 5A of the second vehicle axle 5.

As it can be inferred from FIG. 3, the qvt stage increases the transversal distribution ratio of the applied portions of the driving torque to the second vehicle axle 5 with an increasing reduction of the transfer capability of the second clutch k_HA_L up to their maximum value in Point VI, on which the driving torque applied portion to the second vehicle axle 5 is completely transferred to the second driven wheel 5B of the second vehicle axle 5.

An improvement of the efficiency factor of the power train 1 can be reached in the range of the second vehicle axle 5 through the described invention defined system for controlling and adjusting the second or third clutches k_VA, k_VA_L, as one of the two clutches k_HA_L or k_HA_R are continuously driven without slipping, while the other clutches k_HA_R and/or k_HA_L one of the operating situations depending on the engine output distribution in the power train 1 within the range of the second vehicle axle 5, which will be operated with the corresponding differential rotational speeds. By way of this operating strategy, the friction losses are minimized with all the portions of a clutch controlled all-wheel transmission within the range of the vehicle axles.

The second clutch k_HA_L and the third clutch k_HA_R are only operated slipping at the same time when the first clutch k_VA is operated for setting a desired lengthwise distribution ratio lvt in their synchronous condition as it was described in the operating way, shown in FIG. 2.

It can be inferred from FIG. 4 and FIG. 5 and partially from FIG. 1 in a simple schematic illustration that actuator 8 controls and adjusts the three clutches k_VA, k_HA_L and k_HA_R, whereby the portion shown in FIG. 4 of actuator 8 activates the second clutch k_HA_L and the third clutch k_HA_R by way of two actuators 11 and 12. Each of actuators 11 and 12 activate two ball winding drives 13 and 14 for deploying the second clutch k_HA_L and the third clutch k_HA_R.

The control of actuators 11 and 12 is coupled, with each other in such a way that each can activate the second clutch k_HA_L or the third clutch k_HA_R by activating the third clutch k_HA_R and/or the second clutch k_HA_L, respectively, as well as by activating the corresponding first clutch k_VA. The activation of the second clutch k_HA_L and the third clutch k_HA_R is done without varying the transversal distribution ratio qvt in such a way that the transfer capability of the second clutch k_HA_L or of the third clutch k_HA_R is varied, while the transfer capability of the third clutch k_HA_R and of the second clutch k_HA_L are kept constant in a single value, particularly when the second clutch k_HA_L and the third clutch k_HA_R are working in a synchronized condition.

At the same time, naturally exists the possibility that the transferring capability of the second clutch k_HA_L and of the third coupling k_HA_R can be adjusted for varying the lengthwise distribution ratio lvt in such a way that the second clutch k_HA_L and the third clutch k_HA_R can be synchronously operated while the first clutch k_VA is operated slipping at the same time.

The actuator 8 is built with an electric motor with which the second clutch k_HA_L and the third clutch k_HA_R can activate the actuators 11 and 12, whose rotating drive movement is not convertible by way of the ball winding drives 13 and 14 of the torque converter device in a linear actuation movement for the second clutch k_HA_L and the third clutch k_HA_R. The ball winding drives 13 and 14 are carried out, respectively, by nuts 13A and 14A, with the ball winders 13B, 14B, as well as with the spindles 13C and 14C. Thereby the nuts 13A and 14A fasten an electric motor 24 which drives actuators 11, 12 in a rotary movement in the axial direction. As long as the nuts 13A and 14A remain in functional connection with the ball winders 13B and 14B and with the spindles 13C and 14C. The spindles 13C and 14C of the ball winding drives 13 and 14 are torque proof, connected in such a way with a housing fastened component 15, and displaceable conducted, so that a rotation of each of the nuts 13A and 14A, respectively, one in axial direction of the ball winding drives 13 and 14, controls the translating movement in the axial direction of the ball winding drive spindles 13C and 14C.

The multiple disc clutches existing, respectively, in the second clutch k_HA_L and in the third clutch k_HA_R, which are the multiple disc clutches 16 and 17 depend on the axial position of spindles 13C and 14C of the ball winding drives 13 and 14 to be open or in frictional contact. Thereby the internal discs 16A and 17A of the second clutch k_HA_L and/or of the third clutch k_HA_R are respectively connected with a torque proof drive shaft 18, over which the transmission output torque portion applied to the second vehicle axle 5 from the main transmission 3 on the second clutch k_HA_L and the third clutch k_HA_R are available and torque proof connected. The external discs 16B and/or 17B are also connected with the first driven wheel 5A or with the second driven wheel 5B of the second vehicle axle 5.

Under consideration of the control and adjustment system, described in FIG. 3 for the second clutch k_HA_L and the third clutch k_HA_R is the adjustment of the spindles 13C and 14C of the ball winding drives 13 and 14, depending on the rotational control of the nuts 13A and 14A exerted by the electric motor 11 and 12. This means that the electric motor's 11 and 12 control will depend on the transfer capability of the second clutch k_HA_L and the third clutch k_HA_R. Thereby the spindles 13C and 14C will move respectively in the direction of the translation movement of disc packets 16 and 17, over with the transfer capability of the second clutch k_HA_L and the third clutch k_HA_R is increased. The spindle 13C of the first ball winding drive 13 or the spindle 14C of the second ball winding drives 14 move respectively in the direction of the second winding drive 14 or of the first ball winding drive 13, and the transfer capability of the second clutch k_HA_L and of the third clutch k_HA_R is reduced by lowering the pressing force between the external discs 16B and 17B and the internal discs 16A and 17A.

The two nuts 13A and 14A are supported in the axial direction of the parts of actuator 8, described in FIG. 4, over cylinder rolling bearings 19 and 20 in the axial direction against the drive shaft 18 in functional connection with a conic gear wheel 21. As the disc packets 16 and 17 of the second clutch k_HA_L and the third clutch k_HA_R are arranged with conic rolling bearings 22 and 23, over which an axial actuating movement is realized over each of the spindles 13C or 14C from the discs packets 16 or 17 from the second clutch k_HA_L or the third clutch k_HA_R. In addition, the differential rotational speeds between the discs packets 16 and 17 and the spindles 13C and 14C are compensated with almost no losses over the conic roller bearings 22 and 23 in a simple way.

FIG. 5 illustrates a further part of actuator 8, which is foreseen for controlling the first clutch k_VA. This part of actuator 8 basically corresponds to the part shown in FIG. 4 of actuator 8, which is used for controlling and adjusting the second clutch k_HA_L.

The part of actuator 8, illustrated in FIG. 5, is actuated with a ball winding drive 23 that, in the same way that the ball winding drives 13 and 14 from FIG. 4 work, which is built with a nut 23A, with a ball winder 23B and a spindle 23C. The nut 23A is rotated by an electric motor 24 built an actuator and is fixed in the axial direction of the drive shaft 18. A rotation of the nut 23A causes a translating movement of the torque proof bearing supported the spindle 23C, whereby the translating displacement of the spindle 23C takes place in the direction of a disc packet 25 of the first clutch k_VA, or by the leftward or rightward rotation motion of the electric motor 24.

The corresponding adjustment of the transfer capability of the first clutch k_VA will transfer over the drive shaft 18 of the existing part of the driving torque over internal discs 25A and external discs 25B of the disc packet 25. From there it will be transferred to the first vehicle axle 4. The rolling bearing supported cylinders 26 and 27, shown in FIG. 5, correspond to the constructive adjustment and to the functionality of the bearing supported cylinders 19 and 22, shown in FIG. 4.

Instead of the described electro magnetic control of the three clutches that the invention defined power train, it can also be foreseen that the three clutches are controlled by a hydraulic actuator, whereby the hydraulic actuator can be adjusted as a separate system or can be integrated in the hydraulic control system of the main transmission.

Furthermore, the possibility also naturally exists that the first clutch can be controlled by an electromechanical system, and the second and third clutches are controlled by a hydraulic system. The further control and adjustment of the three clutches can take place over a combined control system, which includes both electro mechanical and hydraulic components as well.

By a beneficial further development of the invention based articles, it is foreseen that the control of the three clutches will be conducted with piezoelectrical or electromagnetic actuators.

Reference Numerals

1 power train
2 main engine, braking force machine
3 main transmission
4 first vehicle axle
4A, B driven wheels of the first vehicle axle
5 second vehicle axle
5A, B driven wheels of the second vehicle axle
6 transversal distribution transmission
7 axial transmission
8 actuator
9 distribution transmission
10 actuator, electric motor
11 actuator, electric motor
12 first ball winding drive
13A nut of the first ball winding drive
13B ball winder of the first ball winding drive
13C spindle of the first ball winding drive
14 second ball winding drive
14A nut of the second ball winding drive
14B ball winder of the second ball winding drive
14C spindle of the second ball winding drive
15 constructive elements fastened to the housing
16 disc packet of the second clutch
16A internal discs of the second clutch
16B external discs of the second clutch
17 disc packet of the third clutch
17A internal discs of the third clutch
17B external discs of the third clutch
18 drive shaft
19, 20 rolling bearing supported cylinder
21 conic gear wheel
22, 23 further rolling bearing supported cylinder
23A nut
23B ball winder
23C spindle
24 electric motor
25 disc packet
25A internal discs
25B external discs
26, 27 roller bearing support cylinders
k_VA first clutch
k_HA_L second clutch
k_HA_R third clutch
l_VA lengthwise distributor power train for the rear axle
lvt lengthwise distribution ratio
qvt transversal distribution ratio
gk_VA transfer capability stage of the first clutch
gk_HA_L transfer capability stage of the second clutch
gk_HA_R transfer capability stage of the third clutch
q_HA_L transversal distribution power train
q_HA_R transversal distribution power train
W(u) lower limit value of the transfer capability of the clutch
W(o) upper limit value of the transfer capability of the clutch

1-11. (canceled)

12. A power train (1) of an all-wheel drive vehicle with at least two driven vehicle axles (4, 5), the power train (1) having a main transmission (3), located between a main engine (2) and the vehicle axles (4, 5), capable of displaying different conversion ratios, the power train (1) having three control and adjustment frictional clutches (k_VA, k_HA_L and k_HA_R) of which a first clutch (k_VA) is placed between the main transmission (3) and a first vehicle axle (4), and a second clutch (k_HA_L) and a third clutch (k_HA_R) are respectively located between an axle transmission (7) and two driven wheels (5A, 5B) of the second vehicle axle (5), whereby respective transfer capabilities of the first, the second and the third clutches (k_VA, k_HA_L and k_HA_R) are adjusted by an actuator (8), and a driving torque between the first and the second vehicle axles (4, 5) is distributed depending on the adjusted transfer capabilities of the first, the second and the third clutches (k_VA, k_HA_L and k_HA_R).

13. The power train according to claim 12, wherein the driving torque applied to the second vehicle axle (5) is distributed, depending on the adjusted transfer capabilities of the second clutch (k_HA_L) and the third clutch (k_HA_R), between the two driven wheels (5A, 5B) of the second vehicle axle (5).

14. The power train according to claim 13, wherein respective actuations over the second clutch (k_HA_L) and over the third clutch (k_HA_R) take place in such a way that the transfer capabilities of the second and the third clutches (k_HA_L and k_HA_R) are varied, depending on a driving stability from an improved transversal distribution ratio (qvt) of a driving torque fraction from the main engine (2) applied to the second vehicle axle (5).

15. The power train according to claim 12, wherein the actuator (8) is one of a hydraulic and an electro mechanical control system.

16. The power train according to claim 12, wherein the actuator is one of a piezo electrical and an electro magnetic control system.

17. The power train according to claim 12, wherein the actuator (8) for controlling and adjusting the transfer capabilities of the first, the second and the third clutches (k_VA, k_HA_L and k_HA_R) is formed by multiple actuators (11, 12, 24).

18. The power train according to claim 17, wherein the multiple actuators (11, 12, 24) respectively can be driven by an electric motor whose rotational driving motion respectively is not convertible by a ball winding drive (13, 14, 23) into a translation activation of the first, the second and the third clutches (k_VA, k_HA_L and k_HA_R).

19. A method for controlling and adjusting a power train (1) of an all-wheel drive vehicle with at least two driven vehicle axles (4, 5), the power train (1) having a main transmission (3), located between a main engine (2) and the vehicle axles (4, 5), capable of displaying different conversion ratios, the power train (1) having three control and adjustment frictional clutches (k_VA, k_HA_L and k_HA_R), of which a first clutch (k_VA) is located between the main transmission (3) and a first vehicle axle (4), and a second clutch (k_HA_L) and a third clutch (k_HA_R) are respectively located between an axle transmission (7) and two driven wheels (5A, 5B) of the second vehicle axle (5), whereby respective transfer capabilities of the first, the second and the third clutches (k_VA, k_HA_L and k_HA_R) are adjusted by an actuator (8), and the driving torque between the first and the second vehicle axles (4, 5) can be distributed depending on the adjusted transfer capabilities of the first, the second and the third clutches (k_VA, k_HA_L and k_HA_R);
the method comprising the steps of adjusting the transfer capabilities of the first, the second and the third clutches (k_VA, k_HA_L and k_HA_R) for a lengthwise distribution of the driving torque between the two driven vehicle axles (4, 5), such that one of the first, the second and the third clutches (k_VA or k_HA_L or k_HA_R) operates under a synchronous condition, while the transfer capabilities of the other two of the first, the second and the third clutches (k HA_L and k_HA_R, or k_VA and k_HA_R, or k_HA_L and k_HA_R) are varied between a lower limit value (W (u)) and an upper limit value (W(o)), in which the synchronous condition of the first, the second and the third clutches (k_VA, k_HA_L or k_HA_R) corresponds.

20. The method according to claim 19, further comprising the steps of:
setting a lower limit value (W (u)) for the transfer capabilities of the first, the second and the third clutches (k_VA, k_HA_L, k_HA_R);
prohibiting transfer of driving torque by one of the first, the second and the third clutches (k_VA, k_HA_L, k_HA_R) to another one of the first, the second and the third clutches (k_VA, k_HA_L, k_HA_R); and
transferring driving torque completely and approximately through the first, the second and the third clutches (k_VA, k_HA_L and k_HA_R) without power losses.

21. The method according to claim 19, further comprising the step of varying a lengthwise distribution ratio (lvt) of driving torque between the two vehicle axles (4, 5) by modifying at least one of:
the transfer capability of the first clutch (k_VA), and the transfer capability of the second clutch (k_HA_L) and of the third clutch (k_HA_R).

22. The method according to claim 19, further comprising the step of adjusting a transversal distribution ratio (qvt) of the driving torque portion applied to the second vehicle axle (5) between two driven wheels (5A, 5B) of the second vehicle axle (5), depending on the transfer capability of the second clutch (k_HA_L) and of the third clutch (k_HA_R).
